(19) United States
(12) Patent Application Publication
(10) Pub. No.: US 2005/0160001 A1
(43) Pub. Date: Jul. 21, 2005

(54) Method for advertising internet web sites

(76) Inventors: Don Lapre, Phoenix, AZ (US); Robin Hanus, Mesa, AZ (US); Jason Beebe, Chandler, AZ (US)

Correspondence Address: ETHERTON LAW GROUP, LLC, 5555 E. VAN BUREN STREET, SUITE 100, PHOENIX, AZ, 85008, US

(21) Appl. No.: 10/762,394

(22) Filed: Jan. 21, 2004

(51) Int. Cl. G06F 17/60

(52) U.S. Cl. 705/14

(57) ABSTRACT

A method in a computer system is used for providing internet advertising. The method includes the step of providing a host web page that includes both attraction content and a reproduction of a client web page, wherein the client web page is advertised to viewers of the host web page. The attraction content may be any type of web page content that could be appealing to a consumer such as humorous videos, images, or works of art. An address such as a URL of the host web page is then transmitted to a consumer.

### FIELD OF THE INVENTION

The present invention relates generally to a method of advertising internet web sites. More particularly the invention relates to a method of advertising internet web sites using emails that include attraction content such as humorous videos.

### BACKGROUND OF THE INVENTION

Businesses are constantly looking for new ways to market their products and services. Businesses generally want as many consumers as possible to see their ads, at the lowest cost possible, which is often calculated as cost per impression. Some of the most successful marketing campaigns combine entertainment with advertising. Also, typically people with email accounts occasionally receive emails containing humorous videos clips. If the recipient finds the video funny and entertaining, the recipient will sometimes forward the video to their friends, family, and colleagues. The result is that a single email can be sent, forwarded by others, and seen by many people. If each person forwards it to even two people, the number of people seeing the email grows geometrically. When the email contains an ad, product information, or call to action, the growth effect is known in the art as viral marketing.

For the best consumer response at a lower cost per impression, it would be desirable to combine entertainment, advertising, and viral marketing. Therefore, a primary object and feature of the present invention is to provide a system for combining entertainment and email-forwarding phenomena to advertise a business and drive traffic to the business's web site.

### SUMMARY OF THE INVENTION

According to one form, the present invention may therefore include a method in a computer system for providing internet advertising. The method may include the step of providing a host web page that includes both attraction content and a reproduction of a client web page, wherein the client web page is advertised to viewers of the host web page. An address of the host web page is then transmitted to a consumer. The attraction content may be any type of web page content that could be appealing to a consumer.

According to another form, the present invention may include a computer data signal, embodied in a transmission medium, for advertising a client web page. The signal may include a code segment including instructions for displaying a host web site, wherein the host web page includes both attraction content and a reproduction of a client web page. The computer data signal may be transmitted over the internet.

According to yet another form, the present invention may include a computer readable medium that includes a computer readable code for providing a host web page. The host web page again includes both attraction content and a reproduction of a client web page.

### BRIEF DESCRIPTION OF THE DRAWINGS

In order that the invention may be readily understood and put into practical effect, reference will now be made to a preferred embodiment as illustrated with reference to the accompanying drawings, wherein like reference numbers refer to like elements, in which:

FIG. 1 is a screen shot of a web page illustrating an exemplary embodiment of the present invention;

FIG. 2 is a screen shot illustrating an exemplary email wherein the URL of a host web page is transmitted from one consumer to another according to the present invention; and

FIG. 3 is a flow diagram illustrating an advertising method according to an embodiment of the present invention.

### DETAILED DESCRIPTION OF THE PREFERRED EMBODIMENTS

Definitions. The following definitions apply in describing the invention disclosed herein:

“Host” means an owner or operator of a web page that is intended to advertise a client web page according to the present invention.

“Client” means an owner or operator of a web page, wherein the web page is intended to be advertised to consumers according to the present invention.

“Consumer” means an individual or group that is a marketing target of a client according to the present invention.

“Attraction content” means any type of web page content that could be appealing to a consumer such as an educational video, a sports video, a crazy video, a humorous video, a pornographic video, a cartoon video, an audio recording, a still image, a writing, a painting, a work of art, a drawing, an informative table, a graphic, or a humorous display other than a video, or any combination of such content. Attraction content further includes hypertext links to any of the above content or other delivery mechanisms for such content, such as multimedia players.

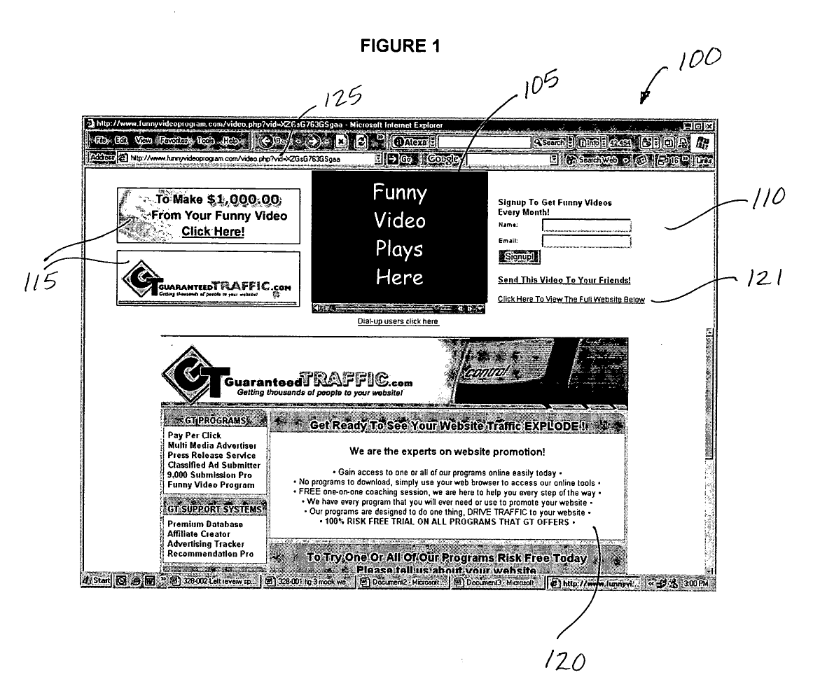

Referring to FIG. 1, there is a screen shot of a web page illustrating an exemplary embodiment of the present invention including a host web page 100 comprising attraction content in the form of a multimedia player 105, a registration form 110, secondary advertisements in the form of banner ads 115, and a client web page reproduction 120.

The host web page 100 is a medium for attracting viewers to the client web site. The attraction content is preferably designed to appeal to consumers who the client would like to have view the client web page. The host web page 100 is thus a way of targeting consumers with an advertisement of the client web page.

The secondary advertisements are preferably also targeted to the same consumers to whom the client web page is targeted. The secondary advertisements may include any type of web-based advertisement such as banner ads 115, pop-up ads, audio ads, etc.

The registration form 110 is a method of encouraging consumers to sign up to receive other host web pages 100 that include other attraction content for advertising either the same client web page or a different client web page. Therefore preferably the registration form 110 includes spaces for inputting a name and email address of a consumer. The registration form 110 may also include spaces for inputting other information such as mailing addresses and consumer preferences.

The client web page reproduction 120 may be any type of client web page that advertises for the client. For example it may be a reproduction of a client's World Wide Web (WWW) home page or it may be another client web page that is targeted to the interests of a particular consumer. Preferably, the client web page reproduction 120 also includes a link 121 to a client web page.

The host web page 100 is preferably identifiable using a unique address such as a Uniform Resource Locator (URL) 125 that identifies a unique web page in the WWW. Preferably the address is a relatively short address so that it can be conveniently copied into an email or web page for easy transmission to consumers. Examples of such URLs include: http://guaranteedtraffic.com/client1/vid1, http://guaranteedtraffic.com/client1/vid2, http://guaranteedtraffic.com/client2/vid1, and http://guaranteedtraffic.com/client2/vid2. In these examples “/client1/vid1” and “/client1/vid2” refer to two separate videos used as attraction content in two separate host web pages for marketing a single client web page to consumers.

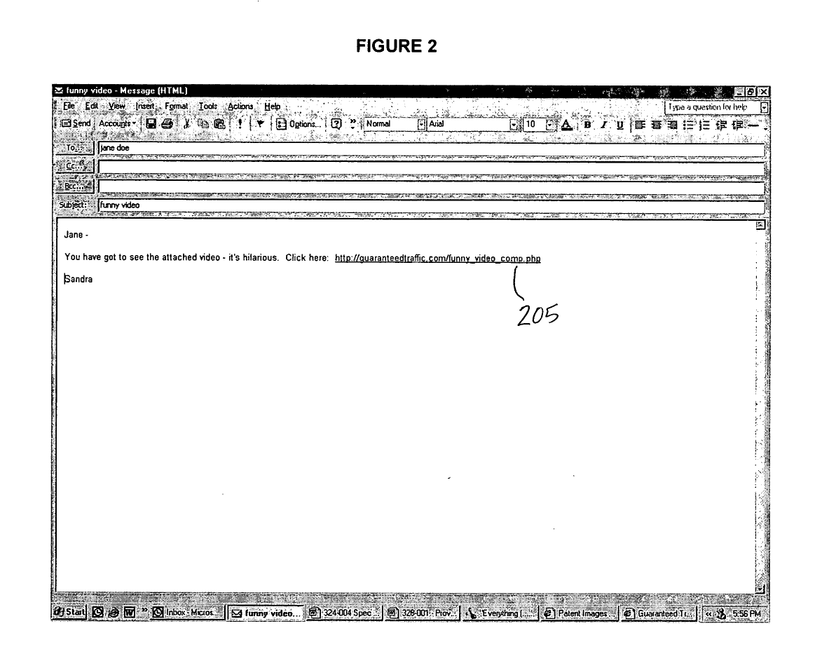

The address of a host web page 100 is intended to be incorporated into electronic communications such as email. Referring to FIG. 2, there is illustrated an example of an email wherein the URL of a host web page 205 is transmitted from one consumer named Sandra to a second consumer named Jane. In this manner the URL of the host web page 100 may be forwarded to numerous consumers through viral marketing.

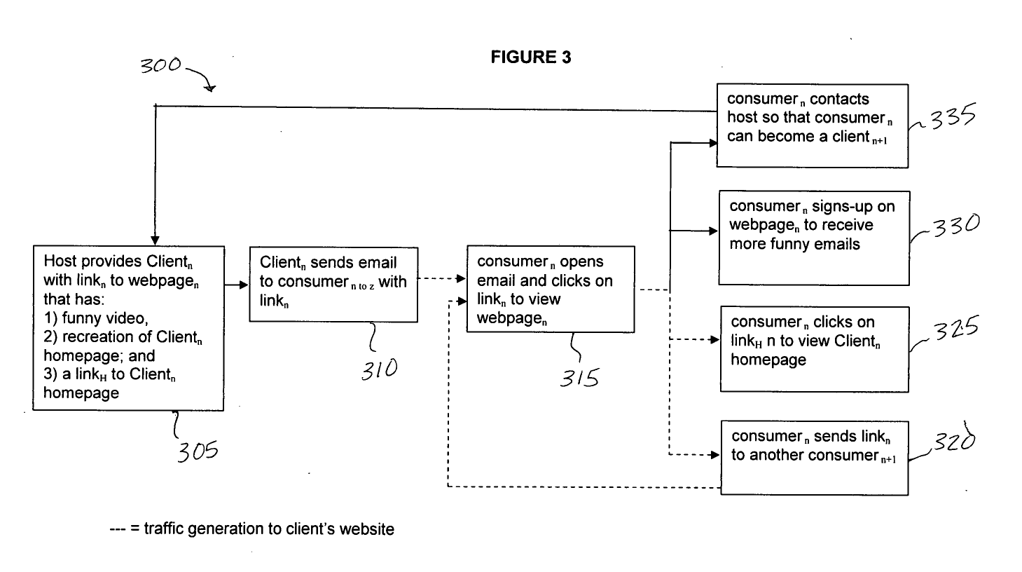

Referring now to FIG. 3 there is a flow diagram illustrating an advertising method 300 according to an embodiment of the present invention. The method 300 begins at step 305 where a host such as an advertising business provides a client with a link to a host web page 100. The host web page 100 includes attraction content such as a funny video, a client web page reproduction 120, and a link to a client home page. Next, at step 310, the client sends an email to one or more consumers where the email includes a link to the host web page 100 provided in step 305. At step 315 a consumer opens the email, views the funny video and also simultaneously views the client web page reproduction 120.

The method 300 then continues to any of steps 320-335. At step 320, the consumer that received the email at step 315 may decide to forward the link to the host web page 100 to a second consumer. Step 315 may then be repeated where the second consumer opens the email, views the funny video and also views the client web page reproduction 120. Through the phenomenon of viral marketing, the cycle from step 315 to step 320 and back to step 315 may be repeated numerous times, resulting in a geometric distribution of the original email. It is intended that consumers will forward the email and link to the host web page 100 to secondary consumers such as friends, family, colleagues, etc., who will also then visit host web page 100. In this way, many more consumers see the funny video and client web page reproduction 120, yet the client does not have to send any further emails. More importantly, because the secondary consumers receive the link to the host web page 100 from someone they know, the secondary consumers are unlikely to dispose of the email as unwanted “spam” email, rather they are more likely to click on the link to the host web age 100. Further, because the secondary consumers are known by the primary consumers to whom the email was sent directly from a client, the secondary consumers are also likely to be preferred recipients of the emails. In other words, if a primary consumer was targeted for advertising by a client because of particular demographic statistics such as income, age, or geography, it is likely that the secondary consumers may also fit similar demographic statistics and thus would also represent preferred targeted recipients of the client's advertising.

Further, at step 325 of the method 300, a consumer who viewed the host web page 100 may proceed to click on a link to view a client web page. The reader will note that the dashed lines in FIG. 3 all represent opportunities for generating traffic to a client web page. At step 330, a consumer who viewed the host web page 100 may proceed to sign up using the registration form 110 on the host web page 100 to receive additional periodic attraction content such as funny videos. If a consumer signs up for more funny videos, the host may send the host web page link to the consumer directly. The host may then record which client's web page the consumer was viewing when the consumer signed up for more videos. The host would then ensure that all future funny videos that go to that consumer would have the appropriate client's web page reproduction 120 attached. Again, in this way many more consumers see the funny videos and connected client homepage, yet the client does not have to send any more emails.

Further, at step 335 of method 300, a consumer who viewed the host web page 100 may proceed to contact the host so that the consumer can become a client of the host. In that case the method 300 returns to step 305 where the host provides a new web page to the new client.

The present invention therefore provides several optional revenue sources. First, clients may pay the host for creating and providing the host web page 100 and the host web page link. Clients also may pay the host each time the host sends out new attraction content to those who signed up from a page created for a client. Also, new attraction content may be acquired by offering payments or prizes to sellers, such as private or amateur artists, who create the attraction content. Alternatively, new funny videos may be acquired by accepting payment from advertising buyers, such as large corporations, who create funny videos. Also, advertisers may pay the host to have secondary advertisements such as banner ads 115 included alongside the attraction content. Further, a host may also elect to provide referral fees to clients who bring significant amounts of traffic to a host web page 100.

Those skilled in the art will recognize that the present invention may be embodied in various forms such as a method in a computer system, a computer data signal embodied in a transmission medium such as media of the World Wide Web, or a computer readable medium such as various types of memory and storage mediums.

In this specification, including the claims, the terms “including,” “comprises,” “comprising” or similar terms are intended to mean a non-exclusive inclusion, such that a method or apparatus that comprises a list of elements does not include those elements solely, but may well include other elements not listed.

It should be understood that the above description is intended to be illustrative and not restrictive. Although the present invention has been fully described concerning the preferred embodiments thereof and with reference to the accompanying drawings, it should be noted that numerous changes and modifications would be readily apparent to those skilled in the art. Such changes and modifications should be understood as included within the scope of the present invention as defined by the appended claims.

1. A method in a computer system for providing internet advertising, the method comprising the steps of:
providing a host web page comprising both attraction content and a reproduction of a client web page, wherein the client web page is advertised to viewers of the host web page; and
transmitting an address of the host web page to a consumer.

2. The method of claim 1, wherein the attraction content comprises a multimedia player and an associated video.

3. The method of claim 1, wherein the attraction content is displayed in an upper portion of the host web page and the reproduction of the client web page is displayed in a lower portion of the host web page.

4. The method of claim 1, wherein the attraction content comprises a link to content selected from the following group: an educational video, a sports video, a crazy video, a humorous video, a pornographic video, a cartoon video, an audio recording, a still image, a writing, a painting, a work of art, a drawing, an informative table, a graphic, and a humorous display other than a video.

5. The method of claim 1, wherein the host web page further comprises a form for registering with an owner or operator of the host web page.

6. The method of claim 1, further comprising the step of emailing a link to the host web page to a plurality of consumers, wherein each of the plurality of consumers are marketing targets of an owner or operator of the client web page.

7. The method of claim 1, wherein the host web page further comprises secondary advertising content.

8. The method of claim 7, wherein the secondary advertising content is selected from the group consisting of: banner advertisements, hypertext links, and pop-up advertisements.

9. The method of claim 1, wherein the step of transmitting an address of the host web page to a consumer comprises emailing a URL.

10. A computer data signal, embodied in a transmission medium, for advertising a client web page, the signal comprising a code segment including instructions for displaying a host web site, wherein the host web page comprises both attraction content and a reproduction of a client web page.

11. The signal of claim 10, wherein the signal is transmitted over the internet.

12. The signal of claim 10, wherein the attraction content comprises a multimedia player for playing a video.

13. The signal of claim 10, wherein the attraction content is displayed in an upper portion of the host web page and the reproduction of the client web page is displayed in a lower portion of the host web page.

14. The signal of claim 10, wherein the attraction content comprises a link to content selected from the following group: an educational video, a sports video, a crazy video, a humorous video, a pornographic video, a cartoon video, an audio recording, a still image, a writing, a painting, a work of art, a drawing, an informative table, a graphic, and a humorous display other than a video.

15. A computer readable medium comprising a computer readable code for providing a host web page comprising both attraction content and a reproduction of a client web page.

16. The computer readable medium of claim 15, wherein the attraction content comprises a multimedia player for playing a video.

17. The computer readable medium of claim 15, wherein the attraction content is displayed in an upper portion of the host web page and the reproduction of the client web page is displayed in a lower portion of the host web page.

18. The computer readable medium of claim 15, wherein the attraction content comprises a link to content selected from the following group: an educational video, a sports video, a crazy video, a humorous video, a pornographic video, a cartoon video, an audio recording, a still image, a writing, a painting, a work of art, a drawing, an informative table, a graphic, and a humorous display other than a video.

19. The computer readable medium of claim 15, wherein the host web page further comprises a form for registering with an owner or operator of the host web page.

20. The computer readable medium of claim 15, further comprising the step of emailing a link to the host web page to a plurality of consumers, wherein each of the plurality of consumers are marketing targets of an owner or operator of the client web page.
